(19) United States
(12) Patent Application Publication
(10) Pub. No.: US 2012/0227362 A1
(43) Pub. Date: Sep. 13, 2012

(54) HYDROPHILIC AND HYDROPHOBIC STERILE BARRIER SYSTEM FOR USE IN STERILIZATION OF SURGICAL IMPLEMENTS

(76) Inventor: George Haase LIMA, Porto Alegre (BR)

(21) Appl. No.: 13/046,411

(22) Filed: Mar. 11, 2011

(51) Int. Cl. B65B 49/00; B32B 5/26; B32B 27/32; B32B 27/08

(52) U.S. Cl. 53/461; 428/516; 442/382

(57) ABSTRACT

The present invention refers to a sterile barrier system composed of: a minimum of one external 100% polypropylene SMS sheet with hydrophobic treatment (water repellent), providing a microbial barrier for bacterial and viral filtration efficiency (BFE and VFE), which meets the requirements of non aqueous propagation of microorganisms or recontamination of the packaging; and a minimum of one internal 100% polypropylene SMS sheet with hydrophilic treatment, that absorbs the excess vapor from inside the packaging and dissipates it by controlled porosity in the autoclave vacuum, under high temperature. This combined hydrophilic and hydrophobic system enhances effectively the performance of the drying cycle in the autoclave, obtaining dry packaging after the sterilization cycle, eliminating the risks of recontamination, preserving the sterility of the packages and reducing costs in the operation.

### SUMMARY OF THE INVENTION

The present invention relates to a sterile barrier system for use in sterilization processes for surgical implements.

### BACKGROUND OF THE INVENTION

### Field of the Invention

The present invention was developed specially for the field of sterilization of surgical implements and instruments and, more specifically, to a sterile barrier system for surgical implements and instruments during the process of sterilization.

According to the International Standard ISO 11607-1: 2006 (E), in order to harmonize the different connotations of the terminology around the world, the term ‘sterile barrier system’ was introduced to describe the minimum packaging required to perform the unique functions required of medical packaging: to allow sterilization, to provide an acceptable microbial barrier, and to allow for aseptic presentation.

In the sterilization center of a hospital, a wide range of routine surgical items are used, such as surgical instruments, trays, gauntlets, bandages and the like. Sterilization is accomplished by any of a variety of methods including saturated steam, formaldehyde, and hydrogen peroxide plasma. It is recommended that surgical articles be previously packed in a medical packaging that ensures high levels of bacterial filtration efficiency (BFE) and viral filtration efficiency (VFE) before being sterilized. Other important considerations are non-emission of particles, non toxicity, non flammability, preservation of sterility, drapability and controlled porosity regarding the sterilizing agent.

The sterilization process routinely used in health institutions is the steam sterilization, where the sterilization occurs by vapor contact, pressure and temperature with the articles being sterilized. For this procedure, the surgical articles must be previously packed with a sterile barrier system that, as mentioned above, assures high levels of bacterial filtration efficiency (BFE) and viral filtration efficiency (VFE). After sterilization the autoclave removes steam from the chamber and dries the packages according to a schedule time program.

The Association of Perioperative Registered Nurses of the United States,—AORN/USA—recommends, for sterilization of the practical perioperative environment, the use of saturated steam under pressure as the preferred method of sterilization. It also recommends that the wrappings in which the implements being sterilized are placed must be completely dry and cooled before the surgical instruments are handled or removed from within the sterilization equipment. At the end of the typical vapor sterilization cycle, after an appropriate drying period, the implements being sterilized and their wrappings may still contain vapor. Touching the wrappings (the sterile barrier system) in this vulnerable stage may compromise the barrier properties of the material of which it is made and allow humidity to pass through. In addition, when hot and cold surfaces enter into contact, humidity will condense in and out of the packing and the passage of liquid through the material of which it is made results in the contained implements being considered non sterile. As a result, in order to assure the desired results of the sterilization process are achieved, it is recommended by AORN/USA that when condensation within the packing is observed, the packing should be considered non sterile and the implements should not be used.

The packaging commonly used for the purpose of sterilization of surgical articles in autoclaves are typically produced of cotton fabric or 100% SMS polypropylene, i.e., polypropylene which is “Spunbond (one or more layers), Meltblown (one or more layers), Spunbond (one or more layers)” as made, as will be understood by those skilled in the art.

Cotton fabric has multiple problems in sterilization applications; it is subject to repeated washing and required monitoring of wear and tear; hospitals are not equipped to limit a maximum amount of reuse; there are no regulations for the manufacture of cotton fabric for surgical use; it is not resistant to humidity; is subject to rapid contamination; accumulates and releases dust and cotton particles; is not an effective microbial barrier; requires frequent re-sterilization; increases storage cost; and is subject to contamination by toxic and non-toxic biodegradable chemicals in the laundry process.

In recent years some medical facilities have begun the use of 100% SMS polypropylene, with a hydrophobic characteristic (repellency to liquids), using one or two sheets to pack the surgical implements.

Hydrophobicity on the external sheet of the 100% SMS polypropylene packaging is entirely justified in view of the thermal shock between different temperatures, i.e., for the inside of the autoclave and in the environment of the sterilization center—at the time of opening of the vapor sterilization equipment or autoclave. Should condensation occur, the hydrophobic characteristics of the 100% SMS polypropylene packaging prevents the water-borne microorganisms from contacting the interior of the package and thus avoid contamination of the instruments from such packaging.

However, as noted above, after the sterilization cycle, the packaging must be completely dry so that the entire sterilization process is validated. After the sterilization cycle, the autoclave automatically removes the steam from inside the chamber and programs a drying cycle. The hydrophobic characteristic of the packaging creates a problem by preventing the complete removal of the steam from inside the packaging, causing the wetness or humidity. When it is identified in the sterilization center that packaging is humid or “wet”, the package is automatically discarded and classified as non sterile. The package is then sent for a repeat of the sterilization process. That is, the package is opened, the contents inspected, rewashed if necessary and then placed in new packaging for a new sterilization cycle.

### BRIEF DESCRIPTION OF THE INVENTION

In accordance with an aspect of the present invention the deficiencies of the conventional sterile barrier system materials for surgical equipment are avoided by optimizing the removal of humidity from the interior of the packaging at the end of the sterilization cycle in the autoclave, thereby assuring the efficiency of the sterile barrier system. This invention diminishes significantly the number of packages rejected due to internal humidity and, consequently, the number of packages that must be subject to repeated sterilization.

The present invention refers to a sterile barrier system composed of: a minimum of one external sheet with hydrophobic treatment (water repellent), providing a microbial barrier for bacterial and viral filtration efficiency (BFE and VFE), which meets the requirements of non aqueous propagation of microorganisms or recontamination of the packaging; and a minimum of one internal sheet with hydrophilic treatment, that absorbs the excess vapor from inside the packaging and dissipates it by controlled porosity in the autoclave vacuum, under high temperature. This combined hydrophilic and hydrophobic system enhances effectively the performance of the drying cycle in the autoclave, obtaining dry packaging after the sterilization cycle, eliminating the risks of recontamination, preserving the sterility of the packages and reducing costs in the operation.

### BRIEF DESCRIPTION OF THE DRAWINGS

The features and advantages of this invention mentioned above will be easily understood in the following detailed description of an illustrative embodiment thereof which is to be read in connection with the accompanying drawing wherein:

FIG. 1 is a perspective view of a sterile barrier system with two sheets (S) for use in the sterilization of surgical implements and material in accordance with the present invention.

FIG. 2 is a schematic diagram illustrating the steps of folding a sterile barrier system sheet of the material of the invention around an object to be sterilized; and

FIG. 3 is a side view of the package after Step 2 shown in FIG. 2.

### DETAILED DESCRIPTION OF THE PREFERRED EMBODIMENTS

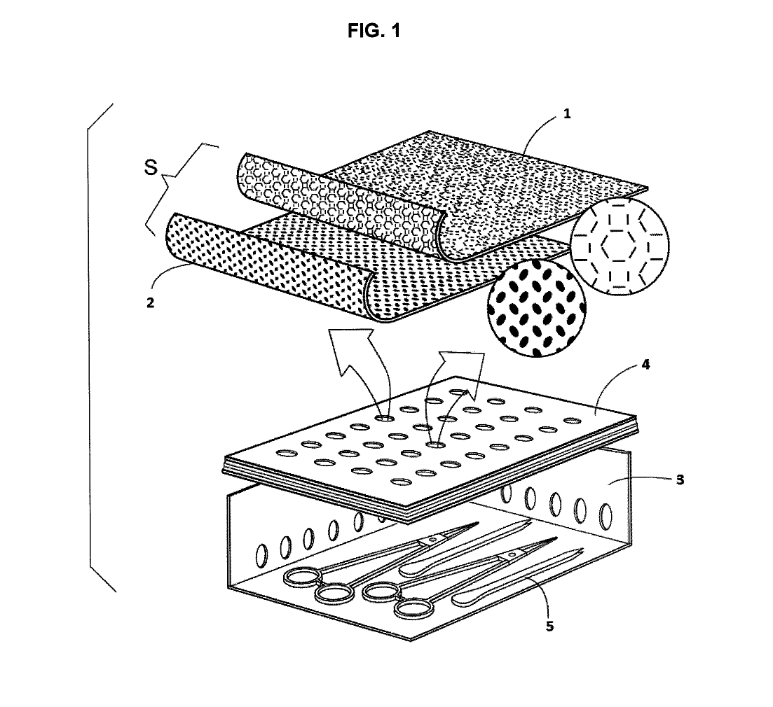

Referring now to the drawing in detail in FIG. 1, a hydrophilic and hydrophobic sterile barrier system (S) for sterilization of surgical articles is illustrated which consists of an external hydrophobic sheet of 100% SMS polypropylene (1) for the repellence of liquids to prevent aqueous conveyance of microorganisms, recontamination of the packaging and to preserve the sterility of the articles; and an internal hydrophilic sheet of 100% SMS polypropylene (2), i.e., absorbs liquid, to dissipate heat and humidity inside the package of articles being sterilized. That is, this internal sheet (2) absorbs excess vapor which is dissipated by the controlled porosity in the autoclave vacuum, under high temperature. The sheets must be used together following the known recommended technique of surgical folding to allow aseptic presentation at the point of use.

In a first embodiment of the invention, the hydrophilic characteristic of the internal sheet (2) is obtained through a treatment of the hydrophobic polypropylene, turning it into an absorbent material, in any convenient or known manner.

In a second embodiment of the invention the hydrophilic characteristic of the internal sheet (2) is formed by coating the internal surface of the sheet with a hydrophilic viscose material or any other absorbent material, aggregated or laminated to the polypropylene sheet in any known manner.

As mentioned above, the two sheets (1 and 2) are used together and may, if desired, be adhered together by a seal or glue. In addition the hydrophobic and hydrophilic sterile barrier system may be formed of multiple separate sheets of hydrophobic and hydrophilic 100% SMS polypropylene or sealed or glued sheets (two sealed or glued sheets; three sealed or glued sheets etc.).

In addition the sheets may be formed or embossed with various patterns, as shown in the enlarged portions of FIG. 1.

The SMS sheets may present one or more Spunbond layers—one or more Meltblown layers—one or more Spunbond layers, as will be understood by those skilled in the art, to adequately prevent waterborne microorganisms from migrating to the internal side of the package and to provide strength to the material.

The sterile barrier system of the present invention may be used, as illustrated in FIG. 1, to wrap a tray (3) which has its own perforated cover (4), containing surgical articles (5), with an internal hydrophilic sheet (2) in direct contact with the tray and an external hydrophobic sheet (1) wrapped around the package, as an outer wrap.

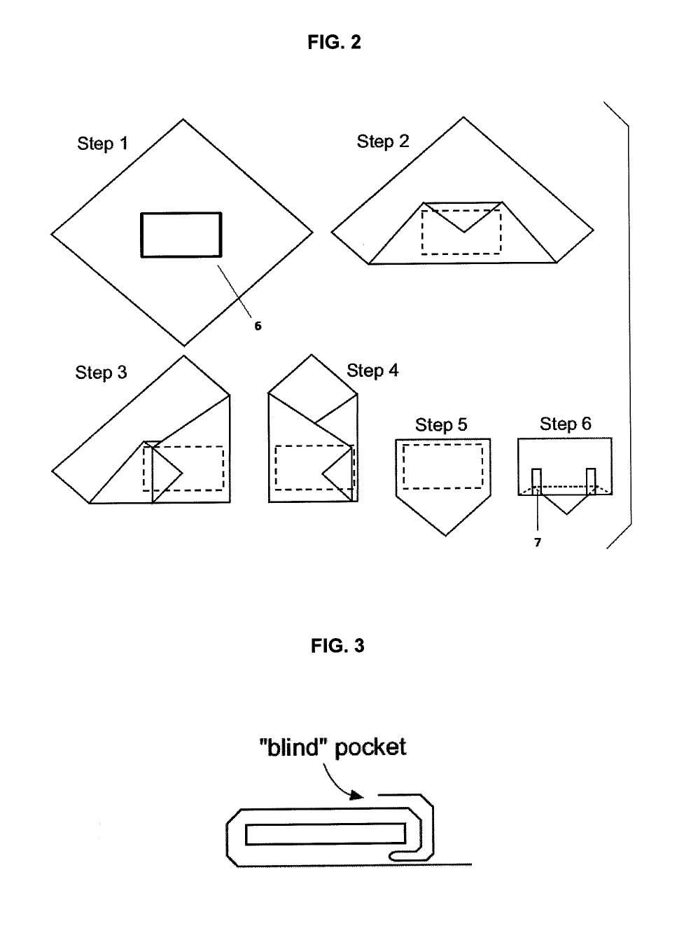

For illustrative purposes FIG. 2 shows an internationally recommended technique for a surgical folding of items to be sterilized, which will be understood by those skilled in the art. In this case a simple tray (6) is illustrated for convenience. In the last step neutral adhesive tape strips (7) are used to seal the last flap.

Although illustrative embodiments of the present invention have been described herein with reference to the accompanying drawings, it is to be understood that the invention is not limited to those precise embodiments and that various changes and modifications may be effected therein by one skilled in the art without departing from the scope or spirit of this invention.

1. A sterile barrier system for use in sterilization of surgical implements comprising at least one external hydrophobic sheet of 100% SMS polypropylene for the repellence of liquids to prevent aqueous conveyance of microorganisms and recontamination of the packaging and to preserve the sterility of the articles; and at least one internal hydrophilic sheet of 100% SMS polypropylene, i.e., absorbs liquid, to dissipate heat and humidity inside the package of articles being sterilized.

2. A sterile barrier system for use in sterilization of surgical implements as defined in claim 1 wherein the hydrophilic characteristic of the internal sheet is obtained through a treatment of the hydrophobic polypropylene, turning it into an absorbent material, in any convenient or known manner.

3. A sterile barrier system for use in sterilization of surgical implements as defined in claim 1 wherein the hydrophilic characteristic of the internal sheet is formed by coating the internal surface of the sheet with a viscose material or any other absorbent material, aggregated or laminated to the polypropylene sheet in any known manner.

4. A sterile barrier system for use in sterilization of surgical implements as defined in claim 1 wherein external hydrophobic sheets and internal hydrophilic sheets are made of 100% polypropylene SMS, in which S may be formed by one or more layers of SPUNBOND, M may be formed by one or more layer of MELTBLOWN and S may be formed by one or more layers of SPUNBOND.

5. A sterile barrier system for use in sterilization of surgical implements as defined in claim 1 which may be formed by multiple sheets—one or more sheets of 100% SMS polypropylene treated to be hydrophilic and one or more sheets of 100% SMS hydrophobic polypropylene.

6. A sterile barrier system for use in sterilization of surgical implements as defined in claim 5 wherein said sheets of 100% SMS hydrophobic polypropylene and 100% SMS polypropylene treated to be hydrophilic are secured together.

7. The method of packing surgical articles for sterilization comprising the step of covering the articles to be sterilized with at least one internal sheet of 100% SMS polypropylene treated to be hydrophilic and at least one external sheet of 100% SMS hydrophobic polypropylene over the hydrophilic sheet.

8. The method as defined in claim 7 including the step of wrapping the articles to be sterilized in at least one internal sheet of 100% polypropylene treated to be hydrophilic.
